(19) United States
(12) Patent Application Publication
(10) Pub. No.: US 2009/0186591 A1
(43) Pub. Date: Jul. 23, 2009

(54) RECEIVER

(75) Inventors: Takeshi Ikeda, Tokyo (JP); Hiroshi Miyagi, Yokohama-shi (JP); Akira Okamoto, Ageo-shi (JP)

Correspondence Address: Connolly Bove Lodge & Hutz LLP;Suite 1100, 1875 Eye Street, NW, Washington, DC, 20006, US

(73) Assignee: NSC CO., LTD., Tokyo (JP)

(21) Appl. No.: 12/355,104

(22) Filed: Jan. 16, 2009

(30) Foreign Application Priority Data
Jan. 17, 2008 (JP) 2008-008433

(51) Int. Cl. H04B 1/16

(52) U.S. Cl. 455/313

(57) ABSTRACT

In a mixer circuit 6 connected in common to output sides of an LNA 2 for FM receiving and an LNA 4 for AM receiving, each of a radiofrequency signal output from the LNA 2 for FM receiving and a radiofrequency signal output from the LNA 4 for AM receiving is frequency-converted into an intermediate frequency signal of a lower intermediate frequency for AM broadcast waves. In this way, receiving of an FM broadcast is performed by a low IF system and receiving of an AM broadcast is performed by a single conversion system; the need for separately providing a mixer circuit, a local oscillation circuit and an IF filter for down-mixing of AM broadcast waves is eliminated.

### BACKGROUND OF THE INVENTION

1. Field of the Invention

The present invention relates to a receiver and, more particularly, to a receiver having circuits for receiving electric waves in a plurality of frequency bands (e.g., an FM receiving circuit and an AM receiving circuit).

2. Description of the Related Art

Radio receivers having an FM receiving circuit using a single conversion system and an AM receiving circuit using a double conversion system including up-conversion are conventionally known. Among radio receivers of this kind, those simplified in configuration by having a circuit section used both for FM receiving and for AM receiving are also known (see, for example, Japanese Patent Laid-Open Nos. 9-186618, 8-149031, and 7-202735).

In the invention disclosed in Japanese Patent Laid-Open No. 9-186618, a mixer circuit for converting a radiofrequency signal (RF signal) into an intermediate frequency signal (IF signal) is used in common for FM receiving and AM receiving. In the invention disclosed in Japanese Patent Laid-Open No. 8-149031, a phase locked loop (PLL) for generating a local oscillation signal used at the time of conversion into an IF signal is used in common for FM receiving and AM receiving. Further, in the invention disclosed in Japanese Patent Laid-Open No. 7-202735, an IF filter for imposing band limitation on an IF signal is used in common for FM receiving and AM receiving.

A radio receiver having a mixer circuit, a local oscillation circuit and an IF filter used both for FM receiving and for AM receiving has recently been provided. FIG. 3 is a diagram showing an example of a configuration of such a radio receiver.

Referring to FIG. 3, two switches are changed to the terminal a side at the time of FM broadcast receiving. A received signal (RF signal) in the form of FM broadcast waves is then amplified by a low-noise amplifier (LNA) 101 for FM receiving and is thereafter converted into an FM-IF signal of a predetermined frequency (e.g., 10.7 MHz) by being frequency-mixed in a first mixer circuit 102 with a local oscillation signal output from a first local oscillation circuit 103. The FM-IF signal output from the first mixer circuit 102 is band-limited by a first IF filter 104, amplified by an IF amplifier 105 for FM receiving and is FM-demodulated by an FM demodulation circuit 106.

At the time of AM broadcast receiving, the two switches are changed to the terminal b side. A received signal (RF signal) in the form of AM broadcast waves is then amplified by an LNA 111 for AM receiving and is thereafter converted into a first AM-IF signal of a predetermined frequency (e.g., 10.7 MHz) by being frequency-mixed in the first mixer circuit 102 with the local oscillation signal output from the first local oscillation circuit 103.

The first AM-IF signal output from the first mixer circuit 102 is band-limited by the first IF filter 104 and is thereafter converted into a second AM-IF signal of a predetermined frequency (e.g., 450 kHz) by being frequency-mixed in a second mixer circuit 112 with a local oscillation signal output from a second local oscillation circuit 113. The second AM-IF signal output from the second mixer circuit 112 is band-limited by a second IF filter 114, amplified by an AM IF amplifier 115 and is AM-demodulated by an AM demodulation circuit 116.

In the radio receiver shown in FIG. 3, as described above, the first mixer circuit 102, the first local oscillation circuit 103 and the first IF filter 104 are used in common for FM receiving and AM receiving.

### SUMMARY OF THE INVENTION

In the above-described conventional radio receiver shown in FIG. 3, however, there is still a need for two IF amplifiers for FM receiving and AM receiving. Also, while the three circuits: the first mixer circuit 102, the first local oscillation circuit 103 and the first IF filter 104 can be used in common for FM frequency conversion and AM up-mixing, there is a need to provide the second mixer circuit 112, the second local oscillation circuit 113 and the second IF filter 114 for AM down-mixing apart from the above-described three circuits.

In view of the above-described problem, an object of the present invention is to provide, as a radio receiver having an FM receiving circuit and an AM receiving circuit for example, a receiver having a further simplified circuit configuration capable of receiving electric waves in a plurality of frequency bands.

To achieve the above-described object, according to the present invention, in a frequency conversion circuit connected in common to output sides of a first-electric-wave radiofrequency amplification circuit and a second-electric-wave radiofrequency amplification circuit, each of a radiofrequency signal output from the first-electric-wave radiofrequency amplification circuit and a radiofrequency signal output from the second-electric-wave radiofrequency amplification circuit is frequency-converted into an intermediate frequency signal of a low intermediate frequency for second electric waves.

According to the present invention arranged as described above, first electric waves (e.g., FM broadcast waves) can be processed by a low IF system and second electric waves (e.g., AM broadcast waves) in a receiving frequency band lower than that for the first electric waves can be processed by a single conversion system. Since the second electric waves are processed by a single conversion system, there is no need to separately provide a frequency conversion circuit, a local oscillation circuit and an intermediate frequency filter for down-mixing of the second electric waves, and the circuit configuration can be simplified. Also, an intermediate frequency amplification circuit connected to the output side of an intermediate frequency filter can be used both for the first electric waves and for the second electric waves. The circuit configuration can also be simplified in this way.

### BRIEF DESCRIPTION OF THE DRAWINGS

FIG. 1 is a diagram showing an example of a configuration of a receiver according to an embodiment of the present invention;

FIG. 2 is a diagram showing another example of a configuration of the receiver according to the embodiment of the invention; and

FIG. 3 is a diagram showing an example of a configuration of a conventional receiver.

### DETAILED DESCRIPTION OF THE PREFERRED EMBODIMENTS

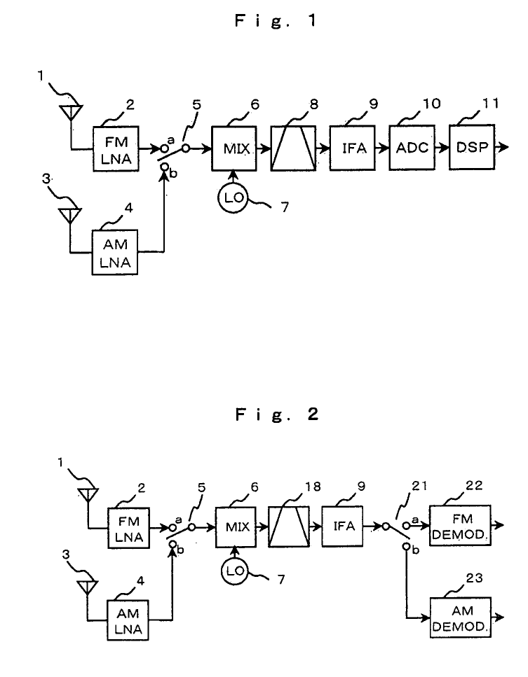

An embodiment of the present invention will be described with reference to the accompanying drawings. FIG. 1 is a diagram showing an example of a configuration of a receiver according to the present embodiments. A configuration of a radio receiver having an FM receiving function and an AM receiving function is expressed as one example in FIG. 1.

As shown in FIG. 1, the radio receiver in the present embodiment has an FM antenna 1, an LNA 2 for FM receiving, an AM antenna 3, an LNA 4 for AM receiving, a switch circuit 5, a mixer circuit 6, a local oscillation circuit 7, an IF filter 8, an IF amplifier 9, an analog-to-digital (A/D) conversion circuit 10 and a digital signal processor (DSP) 11.

The LNA 2 for FM receiving corresponds to the first-electric-wave radiofrequency amplification circuit of the present invention. The LNA 2 for FM receiving amplifies a radiofrequency signal (RF signal) in the form of FM broadcast waves (corresponding to the first electric waves of the present invention) received by the FM antenna 1. The LNA 4 For AM receiving corresponds to the second-electric-wave radiofrequency amplification circuit of the present invention. The LNA 4 for AM receiving amplifies a radiofrequency signal (RF signal) in the form of AM broadcast waves (corresponding to the second electric waves of the present invention) received by the AM antenna 3.

The switch circuit 5 selectively outputs one of the radiofrequency signal output from the LNA 2 for FM receiving and the radiofrequency signal output from the LNA 4 for AM receiving. This switch circuit 5 is changed to the terminal a side at the time of receiving an FM broadcast and is changed to the terminal b side at the time of receiving an AM broadcast. This changing is controlled, for example, on the basis of a control signal output from the DSP 11.

The mixer circuit 6 corresponds to the frequency conversion circuit of the present invention. The mixer circuit 6 is connected in common to the output sides of the LNA 2 for FM receiving and the LNA 4 for AM receiving through the switch circuit 5. The local oscillation circuit 7 generates a local oscillation signal of a predetermined frequency to be supplied to the mixer circuit 6. The mixer circuit 6 mixes the radiofrequency signal output either from the LNA 2 for FM receiving or the LNA 4 for AM receiving with the local oscillation signal output from the local oscillation circuit 7 to convert the radiofrequency signal into an intermediate frequency signal (IF signal).

The IF filter 8 corresponds to the intermediate frequency filter of the present invention. The IF filter 8 imposes band limitation on the intermediate frequency signal output from the mixer circuit 6. In the present embodiment, the IF filter 8 has a pass-band frequency characteristic such as to allow both frequency components of FM broadcast waves and frequency components of AM broadcast waves to pass therethrough, and performs band limitation in accordance with the frequency characteristic. The IF amplifier 9 corresponds to the intermediate frequency amplification circuit of the present invention. The IF amplifier 9 amplifies the intermediate frequency signal output from the IF filter 8. The A/D conversion circuit 10 makes analog-to-digital conversion of the intermediate frequency signal output from the IF amplifier 9.

The DSP 11 corresponds to the digital signal processing circuit of the present invention. The DSP 11 demodulates, by digital signal processing, the intermediate frequency signal output from the A/D conversion circuit 10. The DSP 11 performs FM broadcast wave band limitation (processing for extracting the frequency components of FM broadcast waves) and FM demodulation processing on the intermediate frequency signal output from the A/D conversion circuit 10 when FM broadcast waves are received (when the switch circuit 5 is at the changed position on the terminal a side). Also, the DSP 11 performs AM broadcast wave band limitation (processing for extracting the frequency components of AM broadcast waves) and AM demodulation processing on the intermediate frequency signal output from the A/D conversion circuit 10 when AM broadcast waves are received (when the switch circuit 5 is at the changed position on the terminal b side).

In the mixer circuit 6 in the present embodiment, each of the radiofrequency signal output from the LNA 2 for FM receiving and the radiofrequency signal output from the LNA 4 for AM receiving is frequency-converted into an intermediate frequency signal of a low intermediate frequency (e.g., 450 kHz) for AM broadcast waves. That is, with respect to FM broadcast waves, an intermediate frequency signal is generated by a low IF system for conversion into an intermediate frequency lower than the ordinary intermediate frequency (e.g., 10.7 MHz). On the other hand, with respect to AM broadcast waves, an intermediate frequency signal is generated by a single conversion system not accompanied by up-conversion.

The operation of the radio receiver according to the present embodiment configured as described above will now be described. Referring to FIG. 1, the switch circuit 5 is changed to the terminal a side at the time of receiving an FM broadcast. The RF signal in the form of FM broadcast waves received by the FM antenna 1 is then amplified by the LNA 2 for FM receiving and is thereafter converted into the FM-IF signal having the predetermined frequency (450 kHz) by being frequency-mixed in the mixer circuit 6 with the local oscillation signal output from the local oscillation circuit 7.

The FM-IF signal output from the mixer circuit 6 undergoes band limitation by the IF filter 8, is amplified by the IF amplifier 9 and is converted by the A/D conversion circuit 10 into a digital signal to be input to the DSP 11. In the DSP 11, FM broadcast band limitation and FM demodulation processing are performed on the FM-IF signal input from the A/D conversion circuit 10.

On the other hand, the switch circuit 5 is changed to the terminal b side at the time of receiving an AM broadcast. The RF signal in the form of AM broadcast waves received by the AM antenna 3 is then amplified by the LNA 4 for AM receiving and is thereafter converted into the AM-IF signal having the predetermined frequency (450 kHz) by being frequency-mixed in the mixer circuit 6 with the local oscillation signal output from the local oscillation circuit 7.

The AM-IF signal output from the mixer circuit 6 undergoes band limitation by the IF filter 8, is amplified by the IF amplifier 9 and is converted by the A/D conversion circuit 10 into a digital signal to be input to the DSP 11. In the DSP 11, AM broadcast band limitation and AM demodulation processing are performed on the AM-IF signal input from the A/D conversion circuit 10.

In the radio receiver in the present embodiment, as described above in detail, the mixer circuit 6, the local oscillation circuit 7 and the IF filter 8 are used in common for FM receiving and AM receiving. In the present embodiment, as described above, the single conversion system is used for receiving an AM broadcast as well as for receiving an FM broadcast. Accordingly, the IF filter 8 functions as an FM broadcast antialiasing filter and as an AM broadcast low-pass filter. Conversely speaking, an FM broadcast antialiasing filter and an AM broadcast low-pass filter can be combined into one IF filter 8.

Also, according to the present embodiment, receiving of an FM broadcast can be performed by a low IF system, and receiving of an AM broadcast can be performed by a single conversion system. Because receiving of an AM broadcast is performed by a single conversion system, the need for separately providing a mixer circuit, a local oscillation circuit and an IF filter for down-mixing of AM broadcast waves is eliminated. That is, as shown in FIG. 1, the provision of one mixer circuit 6, one local oscillation circuit 7 and one IF filter 8 may suffice. Further, the IF amplifier 9 connected to the output side of the IF filter 8 can be used both for FM broadcast waves and for AM broadcast waves. Thus, the circuit configuration of the radio receiver can be markedly simplified in comparison with that of the conventional receiver.

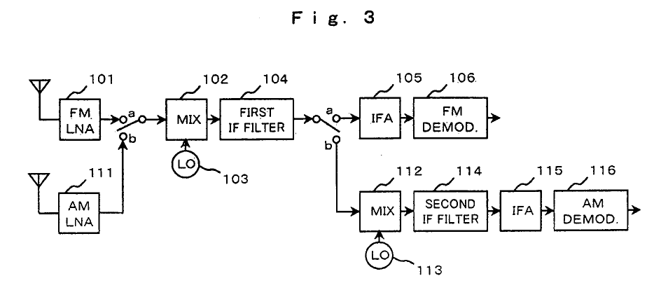

Also, according to the present embodiment, there is no need to separately provide an FM demodulation circuit and an AM demodulation circuit, because FM demodulation processing and AM demodulation processing are selectively performed in the DSP 11. Needless to say, the arrangement may alternatively be such that, as shown in FIG. 2, a switch circuit 21 is provided on the output side off the IF amplifier 9, and an FM demodulation circuit 22 and an AM demodulation circuit 23 are separately provided on the output side of the switch circuit 21. Also in this case, the provision of one mixer circuit 6, one local oscillation circuit 7, one IF filter 18 and one IF amplifier 9 suffices and the circuit configuration can be simplified in comparison with that or the conventional receiver. However, the configuration as shown in FIG. 1 eliminates the need for separately providing an FM demodulation circuit and an AM demodulation circuit and therefore enables further simplification of the circuit configuration.

In the radio receiver configured as shown in FIG. 2, the IF filter 18 performs band limitation so as to allow frequency components of FM broadcast waves to pass therethrough when the FM broadcast waves are received, and performs band limitation so as to allow frequency components of AM broadcast waves to pass therethrough when the AM broadcast waves are received. Switching between the pass bands for this band limitation can be realized, for example, by providing the IF filter 18 in the form of an active filter. More specifically, the IF filter 18 is constituted by a switched capacitor filter for example, and by variably controlling the capacitance value of switched capacitor filter.

The switch circuit 21 outputs the intermediate frequency signal output from the IF amplifier 9 selectively to one of the FM demodulation circuit 22 and the AM demodulation circuit 23. That is, the switch circuit 21 is changed to the terminal a side at the time of receiving an FM broadcast, and to the terminal b side at the time of receiving an AM broadcast. The FM demodulation circuit 22 corresponds to the first demodulation circuit of the present invention and performs FM demodulation processing on the intermediate frequency signal output from the IF amplifier 9. The AM demodulation circuit 23 corresponds to the second demodulation circuit of the present invention and performs AM demodulation processing on the intermediate frequency signal output from the IF amplifier 9.

While the embodiment has been described by referring to a case where the first electric waves are FM broadcast waves and the second electric waves are AM broadcast waves by way of example, the present invention is not limited to the described case. For example, the electric waves may be television broadcast waves, shortwave broadcast waves, any of waves for various mobile communications, or the like. That is, in a receiver capable of receiving two kinds of signals among FM broadcast signals, AM broadcast signals, television broadcast signals, a shortwave broadcast signals, various mobile communication signals, and the like, each of the radiofrequency signal output from the first-electric-wave radiofrequency amplifier circuit and the radiofrequency signal output from the second-electric-wave radiofrequency amplifier circuit is frequency-converted into an intermediate frequency signal of a low intermediate frequency for the second electric waves if the frequency band of the first electric waves is higher than the frequency band of the second electric waves.

The above-described embodiment is only an example of an implementation of the present invention, and the technical scope of the present invention should not be limitatively interpreted therefrom. That is, the present invention can be implemented in various forms without departing from the spirit and the essential features thereof.

This application is based on Japanese Patent Application No. 2008-008433 filed on Jan. 17, 2008, the contents of which are incorporated hereinto by reference.

What is claimed is:

1. A receiver capable of receiving a radiofrequency signal in the form of first electric waves and a radiofrequency signal in the form of second electric waves lower in frequency than the first electric wave; comprising:
a first-electric-wave radiofrequency amplification circuit which amplifies the radiofrequency signal in the form of tile first electric waves received;
a second-electric-wave radiofrequency amplification circuit which amplifies the radiofrequency signal in the form of the second electric waves received;
a frequency conversion circuit connected in common to output sides of the first-electric-wave radiofrequency amplification circuit and the second-electric-wave radiofrequency amplification circuit;
a local oscillation circuit which generates a local oscillation signal lo the frequency conversion circuit;
an intermediate frequency filter which band-limits an intermediate frequency signal output from the frequency conversion circuit; and
an intermediate frequency amplification circuit which amplifies the intermediate frequency signal output from the intermediate frequency filter,
wherein the frequency conversion circuit frequency-converts each of the radiofrequency signal output from the first-electric-wave radiofrequency amplification circuit and the radiofrequency signal output from the second-electric-wave radiofrequency amplification circuit into an intermediate frequency signal of a low intermediate frequency for the second electric waves.

2. The receiver according to claim 1, further comprising:
an A/D conversion circuit which makes analog-to-digital conversion of the intermediate frequency signal output from the intermediate frequency amplification circuit; and
a digital signal processing circuit which demodulates, by digital signal processing, the intermediate frequency signal output from the A/D conversion circuit,
wherein the intermediate frequency filter performs band limitation so as to allow both a frequency component of the first electric waves and a frequency component of the second electric waves to pass therethrough, and
wherein the digital signal processing circuit performs band limitation and demodulation processing for the first electric waves on the intermediate frequency signal when the first electric waves are received, and performs band limitation and demodulation processing for the second electric waves on the intermediate frequency signal when the second electric waves are received.

3. The receiver according to claim 1, further comprising:
a first demodulation circuit which performs demodulation processing for the first electric waves on the intermediate frequency signal output from the intermediate frequency amplification circuit; and
a second demodulation circuit which performs demodulation processing for the second electric waves on the intermediate frequency signal output from the intermediate frequency amplification circuit,
wherein the intermediate frequency filter performs band limitation so as to allow a frequency component of the first electric waves to pass therethrough when the first electric waves are received, and performs band limitation so as to allow a frequency component of the second electric waves to pass therethrough when the second electric waves are received, and
wherein demodulation processing on the intermediate frequency signal is performed in the first demodulation circuit when the first electric waves are received, and demodulation processing on the intermediate frequency signal is performed in the second demodulation circuit when the second electric waves are received.

4. The receiver according to claim 1, wherein the first electric waves are FM broadcast waves, and the second electric waves are AM broadcast waves.
